(19) United States
(12) Patent Application Publication
(10) Pub. No.: US 2008/0184932 A1
(43) Pub. Date: Aug. 7, 2008

(54) Device for Coating, in Particular for Painting Objects, in Particular Vehicle Bodies

(76) Inventors: Markus Albrecht, Abstatt (DE); Steffen Sotzny, Oberstenfeld (DE); Michael Pytkowjat, Ingersheim (DE)

Correspondence Address: FACTOR & LAKE, LTD, 1327 W. WASHINGTON BLVD., SUITE 5G/H, CHICAGO, IL, 60607, US

(21) Appl. No.: 11/660,232

(22) PCT Filed: Jul. 8, 2005
(86) PCT No.: PCT/EP05/07390

§ 371 Date: Sep. 12, 2007

(30) Foreign Application Priority Data
Aug. 19, 2004 (DE) 10 2004 040 162.4

(51) Int. Cl. B05C 13/00

(52) U.S. Cl. 118/500

(57) ABSTRACT

The invention relates to a device for coating, in particular, for painting objects, in particular vehicle bodies (2), comprising at least one multi-axis robot (7) which supports an application device (6). The robot (7) is arranged on a carriage (8) which can be displaced along a guide structure (9). At least one of the media guide chains (12a, 12b) supports a plurality of electric lines and/or lines which guide media and extends from a fixed connection point (40a, 40b) into a loop, which comprises two compartments, to a connection point (41a, 41b) which is transported from the carriage (8). In order to keep the device as laterally compact as possible, at least two media guide chains (2a, 12b) are provided, whereby the loops thereof are arranged on top of each other.

### The invention relates to a device for coating, in particular for painting objects, in particular vehicle bodies, comprising:

a) at least one multi-axis robot which supports an application device;
b) at least one displaceable carriage which supports the robot;
c) a guide structure along which the carriage is displaceable;
d) at least one media guide chain which carries a plurality of electric lines and/or lines which carry media and extends in a loop having two substantially horizontal sections (hereinafter called horizontal sections) from a fixed connection point to a connection point transported by the carriage.

Multi-axis robots which support an application device for the coating medium, for example, a paint spray gun, are used for the fully automatic painting, or otherwise coating, of objects such as vehicle bodies. Their multi-axis configuration enables them to follow precisely the contour of the object to be coated while respecting certain criteria. These criteria include maintaining a given distance from the object to be coated and orienting the spray jet, for example, in such a way that the latter always impinges perpendicularly on the surface to be coated.

The application device, the robot and the carriage transporting the robot, that is, the displaceable components of the coating device, must be connected via a large number of lines having fixed connections. These may be electric lines, in particular lines which carry electric operating voltages or electric control signals. Another group of lines is used to transport gaseous, powdery or liquid media to the carriage, to the robot or, in some cases, to the application device. These media are, in particular, compressed air, paints and solvents. The number of such lines used in modern coating devices of the type mentioned in the introduction is constantly increasing with the growing complexity of these devices. To guide them tidily, use is made of media guide chains to which the individual lines are fixed, so that they form a tidy loop as the carriage is moved. Because of the large number of lines, the media guide chains of known devices of the type mentioned in the introduction are very wide, which is reflected in a corresponding widening of the overall dimensions of the devices.

It is the object of the present invention so to configure a device of the type mentioned in the introduction that its space requirement is reduced, in particular in a direction perpendicular to the direction of transportation.

This object is achieved in that
e) at least two media guide chains are provided, the horizontal sections of which are arranged above one another.

According to the invention, therefore, the total number of electrical or media-carrying lines is divided into at least two groups, to each of which a media guide chain is allocated. The media guide chains are so disposed that their horizontal sections are arranged one above the other. In the vertical direction sufficient room is generally available, so that in particular the base area occupied by the device, which is generally restricted, can be kept small.

At least two media guide chains can be associated with the same carriage. This variant of the invention is used in cases where an especially large number of lines must be guided to one and the same carriage, or to the robot transported thereby and to the application device transported by the robot.

In another embodiment of the invention at least two media guide chains are associated with different carriages. This embodiment is used in cases where the large number of lines results from the need to move a plurality of carriages in substantially the same space.

Thus it occurs that in many high-capacity devices of the type mentioned in the introduction two carriages each carry one robot supporting an application device. The case also frequently arises that at least one of the carriages supports a so-called “handling robot”. The latter is used in the painting process, for example, to move certain parts of the object to be painted, such as the doors of a vehicle body, so that all surfaces of these parts can be correctly reached by the coating medium.

The at least two media guide chains, the horizontal sections of which are arranged one above another, may also be, in particular, nested inside one another. This means that the two horizontal sections of the one chain are located inside the two horizontal sections of another chain and that the chain mentioned first forms a loop with a smaller radius of curvature than the chain mentioned second.

Alternatively, it is possible that at least one media guide chain is arranged with both horizontal sections above the two horizontal sections of another media guide chain.

In an especially advantageous embodiment of the invention, adjacent horizontal sections of at least two media guide chains are located at least zonally against one another. Not only is space in the vertical direction saved thereby; in addition, the two media guide chains located zonally against one another guide each other mutually.

Embodiments of the invention are explained in more detail below with reference to the drawings, in which:

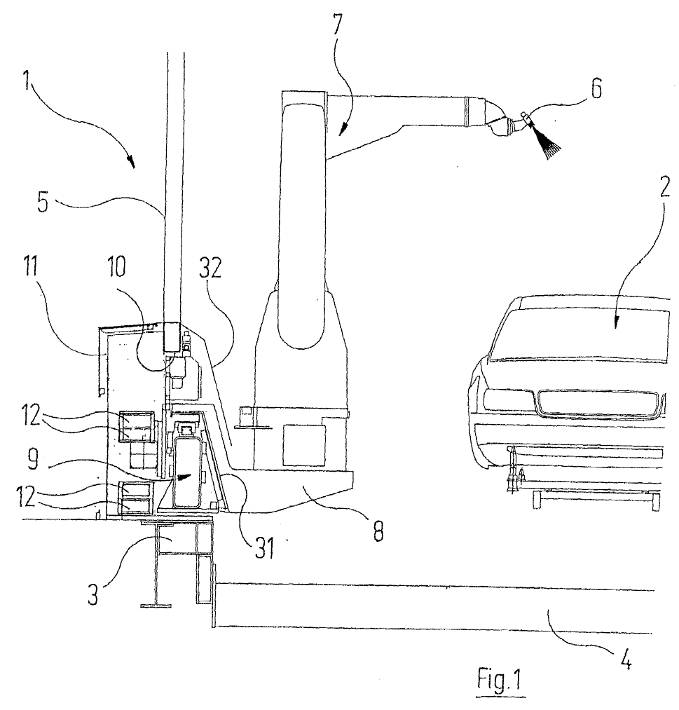

FIG. 1 shows a partial section through a paint spray cabin for painting vehicle bodies;

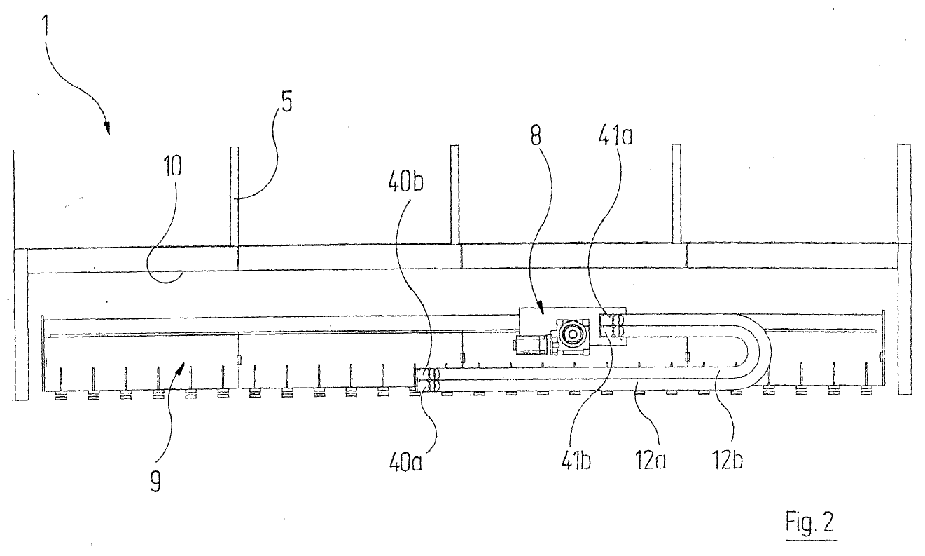

FIG. 2 shows a side view of the paint spray cabin of FIG. 1, viewed from the outside;

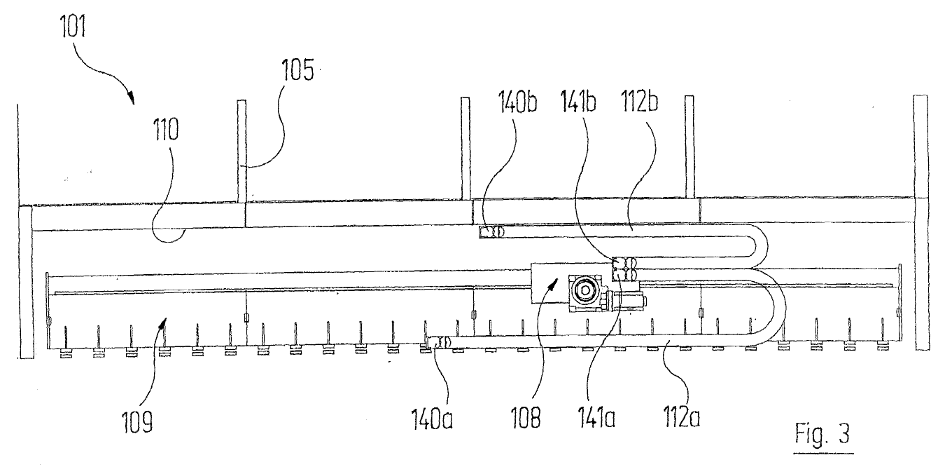

FIGS. 3 to 7 show side views of alternative embodiments of paint spray cabins.

In FIG. 1 a portion of a paint spray cabin as used for painting vehicle bodies 2 is denoted as a whole by reference 1. It is supported by a steel structure of which only a horizontal beam 3 can be seen in the drawing. The paint spray cabin 1 is delimited at the bottom by a floor structure 4 (not of further interest here), on each side by side walls 5 which may be transparent, and at the top by a roof structure (not shown and not of interest here). The vehicle bodies 2 are moved continuously or intermittently through the cabin 1 by a conveyor system (not shown) in a direction perpendicular to the drawing plane, while being painted in the manner described below.

The painting of the vehicle bodies 2 is carried out by means of a spray gun 6 which is guided by a six-axis robot denoted as a whole by reference 7. The robot 7 is in turn mounted on a carriage 8 which is displaceable along a guide structure 9, explained in more detail below, parallel to the direction of motion of the vehicle bodies 2, that is, along the adjacent side wall 5.

A side-housing 11, in which are housed various components required for supplying and operating the carriage 8 and the robot 7, is attached to the lower portion of each of the side walls 5 of the paint spray cabin 1 and is connected to the interior thereof via a wide slot-like access opening 10. Said components are, in particular, electric and pneumatic control systems, valves, electric lines and supply lines for delivering paint and compressed air (all not illustrated), and two media guide chains 12a, 12b. Retained thereon are the various electric and media-carrying connecting lines which are guided in a loop from a fixed connection point 40a, 40b in the region of the side-housing 11 to a connection point 41a, 41b transported with the carriage 8 (cf. FIG. 2).

The fixed connection points 40a, 40b are located approximately at the centre of the longitudinal extension of the paint spray cabin 1. As the term “connection point” indicates, the connection between the fixed, optionally rigid electric and media-carrying lines to the, in all cases flexible, electric and media-carrying connecting lines which are retained and ordered by the media guide chains 12a, 12b, is effected at that location. In a corresponding manner the electric and media-carrying connecting lines are connected at the connection points 41a and 41b transported by the carriage 8 to corresponding lines which lead to the is consumers of electrical energy or electric signals or media transported by the carriage 8. These may be electric currents and signals serving the movement of the carriage 8, and currents and signals required for the movement of the robot 7 and for feeding and activating the paint spray gun 6.

The media-carrying lines in question are primarily lines for supplying paint, lines for supplying solvents and lines for supplying compressed air. The number of lines supplying paint depends on the technology used. In the simplest case the number of connecting lines carrying paint equals the number of paints which are processed in the paint spray cabin 1. Using the “pig” method, which is known to a person skilled in the art and does not need to be described in detail here, the number of lines carrying paint can be considerably reduced.

In any case, the total number of lines running between the fixed connection points 40a, 40b and that of the connection points 41a, 41b transported by the carriage 8 is very high. To prevent the media guide chains accommodating all these lines from requiring too much width (that is, in a direction perpendicular to the transport direction of the carriage 8), two media guide chains 12a, 12b, which are arranged not beside but above one another, are provided in the manner represented in FIGS. 1 and 2. In FIGS. 1 and 2 the two media guide chains 12a, 12b are nested one inside the other in such a way that the adjacent horizontal sections of the two media guide chains 12a, 12b rest substantially against one another at least over a certain distance.

The machine control unit, which controls the transmission of electrical energy, electric signals and different media from the fixed connection points 40a, 40b to the connection points 41a, 41b transported by the carriage 8, is accommodated in the vicinity of the fixed connection points 40a, 40b in the side-housing 11 (not shown).

The loop formed by the media guide chains 12a, 12b and the connecting lines retained therein is long enough for the carriage 8 to be displaced over the full length of the guide structure 9 during operation of the paint spray cabin 1.

The whole guide structure 9 is protected on its side facing inwards and upwards by a sheet metal cover 31 which at the same time prevents contaminants such as paint mist from entering the interior of the side-housing 11. A further sheet metal cover 32 is fixed by its upper edge to the inner side of the cabin wall 5 above the slot-like access opening 10, and extends so far down that it laterally overlaps the lower sheet metal cover 31. To prevent dirt from entering the side-housing 11 through the gap between the two sheet metal covers 31, 32, the interior of the side-housing 11 is maintained at a higher pressure than the interior of the paint spray cabin 1.

During operation of the above-described paint spray cabin 1 the vehicle bodies 2, as described above, are moved intermittently or continuously perpendicularly to the drawing plane of FIGS. 1 and 2, for example, upwardly. During this movement or while at a standstill the vehicle bodies 2 are coated with the aid of the paint spray gun 6 which, using the seven axes of the robot 7, is moved in such a way that all regions of the vehicle body 2 which are to be painted are reached, the most favourable distance between spray gun 6 and vehicle body 2, and the most favourable orientation of the paint mist, being adjusted. As this happens the robot 7 may be moved along its “seventh axis” predefined by the guide structure 9, either in order to paint along a stationary vehicle body 2 in a horizontal direction, or to follow a moving vehicle body 2.

The embodiment of a paint spray cabin shown in FIG. 3 strongly resembles that described above with reference to FIGS. 1 and 2; corresponding parts are therefore denoted by the same references plus 100.

The essential difference between the embodiment of FIGS. 1 and 2 on the one hand and that of FIG. 3 on the other is that, in the latter, the two media guide chains 112a, 112b are not nested inside one another. Rather, the lower media guide chain 112a runs from the fixed connection point 140a arranged in the lower region of the guide structure 109 in a (single) loop to the connection point 141a transported by the carriage 108. By contrast, the upper media guide chain 112b extends wholly above the first media guide chain 112a from a connection point 140b rigidly connected to the housing and located above the guide structure 109 to the connection point 141b transported by the carriage 108. The adjacent horizontal sections of the two media guide chains 112a, 112b rest against one another over a certain distance.

In the embodiment shown in FIG. 3 the control unit is also located in the vicinity of the fixed connection points 140a, 140b in the side-housing.

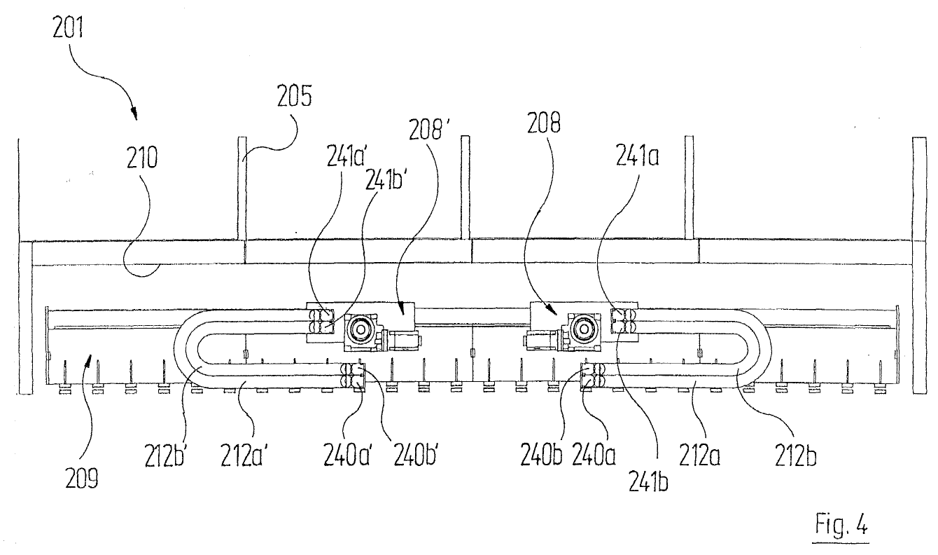

The upper media guide chain 112b holds and orders only electric connecting lines, while connecting lines carrying gas, particles or liquid are guided by the lower media guide chain 112a. In this way it is avoided that, in the event of leakage or rupture of one of the last-mentioned connecting lines, the medium carried therein drips or flows downwardly on to connecting lines conducting current.

Whereas, in the embodiments described above with reference to FIGS. 1 to 3, only one carriage 8; 108 with one corresponding robot 7, could be moved along the guide structure 9; 109, in the embodiment of FIG. 4, in which corresponding parts have references again increased by 100, two carriages 208, 208′ supporting robots are provided. The connection points 241a, 241b and 241a′, 241b′ transported by the carriages 208, 208′ are connected in the same way via two nested and looped media guide chains 212a, 212b and 212a′, 212b′ to the fixed connection points 240a, 240b and 240a′, 240b′ respectively. That is to say that the media guide chains 212a, 212b and 212a′, 212b′ are disposed in nested loops resting against one another. However, the corresponding loops are oriented in opposite directions for the two carriages 208, 208′.

The carriages 208, 208′ can each be moved on the guide structure 209 to the extent that they are not blocked by the respective other carriage 208, 208′. The overall control system of the installation ensures that the carriages 208, 208′ always move only by the appropriate amount.

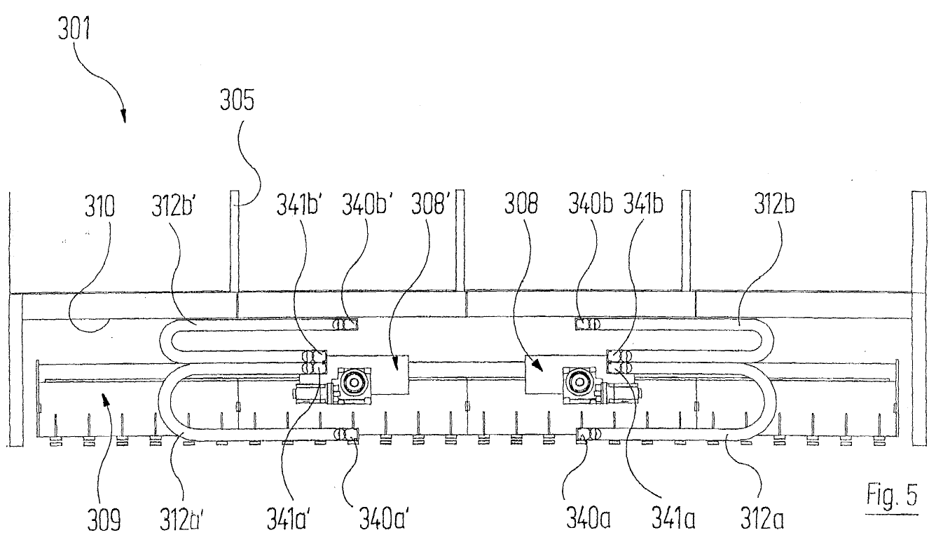

In the embodiment of FIG. 5, which again has references increased by 100, two carriages 308, 308′ supporting painting robots are again movable on the same guide structure 309′, with the geometrical restrictions on their travel distance which were noted above with reference to the embodiment of FIG. 4. In FIG. 5 the media guide chains 312a, 312b and 312a′, 312b′ are disposed in the same way as in FIG. 3, the loops of the media guide chains 312a, 312b and 312a′, 312b′ again being oriented in opposite directions.

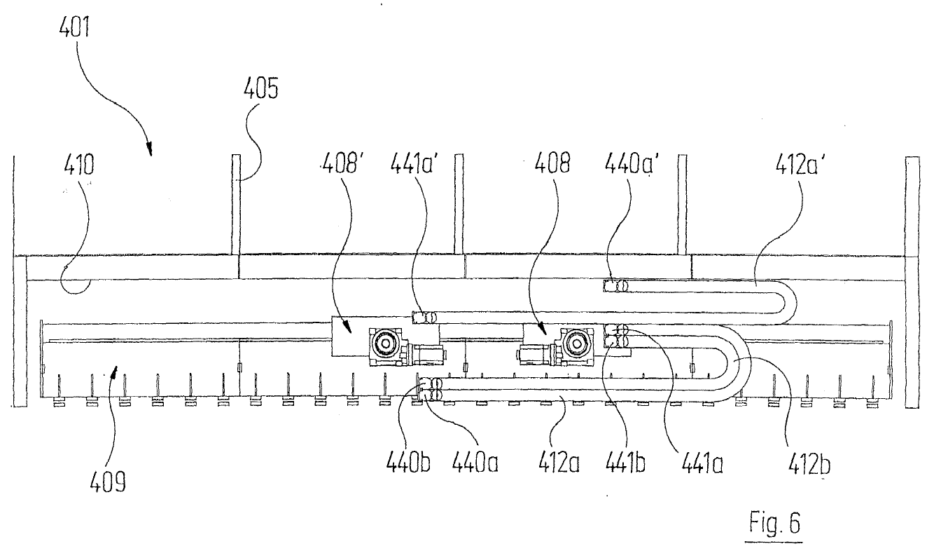

In the embodiment of FIG. 6, which is again provided with references increased by 100, a carriage 408 which carries a painting robot, and a carriage 408′ with which a handling robot is displaced, are moved on one and the same guide structure 409. Handling robots in paint spray cabins are generally used to move certain parts of the vehicle bodies to be painted, e.g. doors, so that all their surfaces can be correctly reached by the paint mist dispensed by the paint spray gun.

As FIG. 6 makes clear, the carriage 408 carrying the painting robot is connected via two media guide chains 412a, 412b in a similar way as in FIG. 2, whereas the carriage 408′ carrying the handling robot is connected to a fixed connection point 440a′ via a single media guide chain 412a′. A part of the lower horizontal section of the media guide chain 412a′ rests against the upper side of the upper horizontal section of the media guide chain 412a, but curves upwards, on the right in FIG. 6, into its upper horizontal section connected to the connection point 440a′.

Self-evidently, the movement of the two carriages 408, 408′ carrying robots in FIG. 6 is subject to the same restrictions resulting from the fact that both move on the same guide structure 409. Such restrictions of mobility are possible and unproblematic precisely with the combination of carriages carrying painting robots and handling robots.

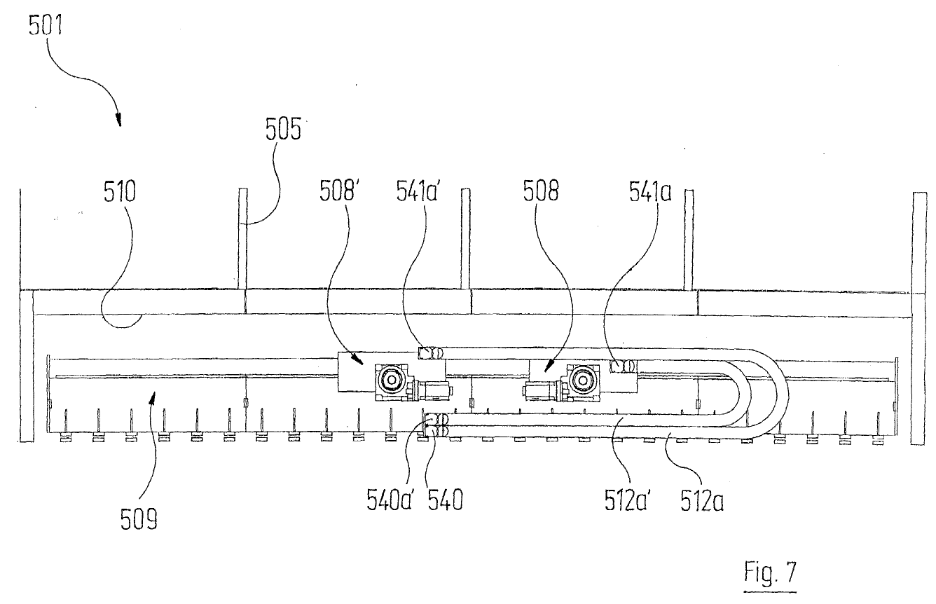

FIG. 7 also shows an embodiment of a paint spray cabin 501 (references are again increased by 100), in which a carriage 508 supporting a painting robot and a carriage 508′ supporting a handling robot move on a single guide structure 509. The carriages 508, 508′ are each connected to the respective fixed connection points 540a, 540a′ via a single media guide chain 512a, 512a′ arranged in a loop. The two media guide chains 512a, 152a′ are nested in one another similarly to the embodiment of FIG. 2, in such a way that their horizontally disposed sections each rest over a part of their extension against an adjacent horizontal section of the other media guide chain 512a, 512a′.

1. A device for coating objects, the device comprising:
at least one multi-axis robot which supports an application device;
at least one displaceable carriage which supports the robot;
a guide structure along which the carriage is displaceable;
at least one media guide chain which carries a multiplicity of electric and/or media-carrying lines and extends in a loop having two horizontal sections from a fixed connection point to a connection point transported by the carriage;
wherein
at least two media guide chains are provided, the horizontal sections of which are arranged above one another.

2. The device of claim 1, wherein the at least two media guide chains are associated with the same carriage.

3. The device of claim 1, wherein the at least two media guide chains are associated with different carriages.

4. The device of claim 3, wherein two carriages each carry a robot supporting an application device.

5. The device of claim 4, wherein at least one carriage supports a handling robot.

6. The device of claim 1, wherein the at least two media guide chains are nested inside one another.

7. The device of claim 1, wherein both horizontal sections of the at least one media guide chain are arranged above both horizontal sections of another media guide chain.

8. The device of claim 1, wherein adjacent horizontal sections of the at least two media guide chains rest against one another at least zonally.

9. The device of claim 2 wherein the at least two media guide chains are associated with different carriages.

10. The device of claim 9, wherein two carriages each carry a robot supporting an application device.

11. The device of claim 10, wherein at least one carriage supports a handling robot.

12. The device of claim 2, wherein the at least two media guide chains are nested inside one another.

13. The device of claim 2, wherein both horizontal sections of the at least one media guide chain are arranged above both horizontal sections of another media guide chain.

14. The device of claim 12, wherein adjacent horizontal sections of the at least two media guide chains rest against one another at least zonally.

15. The device of claim 5, wherein the at least one carriage supports a handling robot.

16. The device of claim 15, wherein the at least two media guide chains are nested inside one another.

17. The device of claim 16, wherein both horizontal sections of the at least one media guide chain are arranged above both horizontal sections of another media guide chain.

18. The device of claim 17, wherein adjacent horizontal sections of the at least two media guide chains rest against one another at least zonally.
